(19) United States
(12) Patent Application Publication
(10) Pub. No.: US 2009/0281252 A1
(43) Pub. Date: Nov. 12, 2009

(54) Novel thermoplastic elastomer-resin alloy composition and preparation method thereof

(75) Inventors: Ah Hyun Bae, Suwon-si (KR); Hye Ran Yoon, Cheonan-si (KR); Iwata Takao, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/292,755

(22) Filed: Nov. 25, 2008

(30) Foreign Application Priority Data
May 8, 2008 (KR) 10-2008-0042868

(51) Int. Cl. C08G 18/44

(52) U.S. Cl. 525/452

(57) ABSTRACT

A thermoplastic elastomer-resin alloy composition, includes 1 to 99% by weight of a thermoplastic elastomer and 1 to 99% by weight of a resin, and a method sets forth preparation of the composition. More specifically, a novel thermoplastic elastomer alloy resin composition has softness, color variety, impact resistance, water resistance, durability, abrasion resistance and rigidity, and is suitable for use as an interior/exterior material for a variety of products.

### CROSS-REFERENCE TO RELATED APPLICATIONS

This application claims the benefit of Korean Patent Application No. 2008-0042868, filed on May 8, 2008 in the Korean Intellectual Property Office, the disclosure of which is incorporated herein by reference.

### BACKGROUND

1. Field

The present invention relates to a novel thermoplastic elastomer resin alloy composition and a method for preparing the composition. More specifically, the present invention relates to a novel thermoplastic elastomer alloy resin composition with soft touch feeling, color variety, impact resistance, water resistance, durability, abrasion resistance and rigidity, suitable for use as an interior/exterior material for a variety of products, and a method for preparing the composition.

2. Description of the Related Art

The term “thermoplastic elastomer” refers to a polymeric material that is plasticized at high temperature, like plastics, and exhibits rubber-elastomeric properties at ambient temperature. That is, such a thermoplastic elastomer is a material between a rubber and a resin, which has both elasticity as the inherent characteristic of rubbers and plasticity as the inherent characteristic of thermoplastic resins. Based on characteristics such as softness, color variety, impact resistance, water resistance, durability, abrasion resistance and rigidity, thermoplastic elastomers are preferred as interior/exterior materials of a variety of products. However, thermoplastic elastomers have a weak mechanical strength (rigidity), as compared with resins, thus being insufficiently durable to be used exclusively as exterior materials.

In conventional cases, to reinforce insufficient rigidity of thermoplastic elastomers, a thermoplastic elastomer is subjected to double injection molding in conjunction with a resin, or is subjected to injection molding by over-molding on the resin, to form the appearance of products, thus protecting the products from external stimuli, based on the rigidity of the resin, and imparting impact resistance and softness to the products due to the elasticity of the thermoplastic elastomer.

However, thermoplastic elastomers are different from resins in terms of thermodynamic structure, thus causing a significant deterioration in bonding strength therebetween. In addition, double injection and overmolding have many disadvantages in that they are in opposition to the recent trends toward slimness and a light weight and involve a greater manufacturing time and greater expense.

Furthermore, there are several conventional methods for preparing thermoplastic elastomer-resin alloys, based on dynamic vulcanization techniques or dynamic crosslinking techniques using additives such as mixing agents and crosslinking agents (e.g. Korean Patent Laid-open Publication Nos. 1999-0021569, 1999-0054418, 1995-0003370, 2007-0027653, 2006-0120224, etc.). That is, in accordance with the conventional methods, thermoplastic elastomer-resin alloys are prepared by chemically decomposing thermoplastic elastomers and resins.

These conventional methods suffer from numerous disadvantages, including requiring the use of other compounds such as mixing agents, fillers, initiating agents and crosslinking agents and taking an excessively long time to synthesize or polymerize thermoplastic elastomers and resins. In addition, conventional thermoplastic elastomer-resin alloys have a strict restriction in that the thermoplastic elastomers and resins must be selected from those that have a mutual chemical affinity.

### SUMMARY

Therefore, in an attempt to solve the problems of the prior art, it is an aspect of the invention to provide a novel thermoplastic elastomer alloy resin composition wherein softness, color variety, impact resistance, water resistance, durability, abrasion resistance and rigidity are secured via physical modification, rather than chemical decomposition, and a method for preparing the composition.

The present invention provides a thermoplastic elastomer alloy resin composition using thermoplastic elastomers and resins that have a low mutual chemical affinity, in comparison with the prior art, and a method for preparing the composition.

In accordance with one aspect of the invention, a thermoplastic elastomer-resin alloy composition comprises 1 to 99% by weight of a thermoplastic elastomer and 1 to 99% by weight of a resin.

Preferably, the thermoplastic elastomer is at least one selected from the group consisting of thermoplastic urethane elastomers (hereinafter, referred to as “TPU”), thermoplastic ester elastomers, thermoplastic styrene elastomers, thermoplastic olefin elastomers, thermoplastic polyvinyl chloride elastomers and thermoplastic amide elastomers.

Preferably, the resin is a thermoplastic plastic.

More preferably, the thermoplastic plastic is at least one selected from the group consisting of polyvinyl chloride, polystyrene, polyethylene, polypropylene, acryl, nylon, polycarbonate (hereinafter, referred to as “PC”), polymethyl methacrylate (PMMA) and acrylonitrile butadiene styrene (ABS) copolymers.

In accordance with another aspect of the invention, a method for preparing a thermoplastic elastomer-resin alloy composition comprises: heating 1 to 99% by weight of a dried thermoplastic elastomer and 1 to 99% by weight of a dried resin with stirring; cooling the resulting mixture; and pelletizing the mixture, followed by drying.

Preferably, the thermoplastic elastomer is selected from the group consisting of thermoplastic urethane elastomers (hereinafter, referred to as “TPU”), thermoplastic ester elastomers, thermoplastic styrene elastomers, thermoplastic olefin elastomers, thermoplastic polyvinyl chloride elastomers and thermoplastic amide elastomers.

Preferably, the resin is a thermoplastic plastic.

More preferably, the thermoplastic plastic is at least one selected from the group consisting of polyvinyl chloride, polystyrene, polyethylene, polypropylene, acryl nylon, polycarbonate (hereinafter, referred to as “PC”), polymethyl methacrylate (PMMA), and acrylonitrile butadiene styrene (ABS) copolymers.

More preferably, the thermoplastic elastomer and the resin are heated to about 200 to 250° C.

More preferably, the thermoplastic elastomer and the resin are stirred at a rate of 40 to 100 rpm.

More preferably, the mixture is cooled to about 50 to 110° C.

The thermoplastic elastomer-resin alloy composition of the present invention contains no other chemicals such as mixing agents, fillers, initiating agents and crosslinking agents, thus securing desired properties via physical modification, rather than chemical decomposition.

Additional aspects and/or advantages of the invention will be set forth in part in the description which follows and, in part, will be apparent from the description, or may be learned by practice of the invention.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, a method to prepare the thermoplastic elastomer-resin alloy composition will be illustrated in detail.

(1) Feeding Materials

A thermoplastic elastomer and a resin to prepare the thermoplastic elastomer-resin alloy were dried in a dehumidifying dryer, 1 to 99% by weight of the thermoplastic elastomer and 1 to 99% by weight of the resin were fed into respective feeder hoppers, and were then subjected to calibration.

Preferably, the resin is a thermoplastic plastic which is flowable at high temperatures. The thermoplastic plastic includes all plastics that are plasticized in a molten state by heating, and that freeze when cooled.

Examples of thermoplastic plastics include, but are not limited to, polyvinyl chloride (PVC), polystyrene (PS), polyethylene (PE), polypropylene (PP), acryl, nylon (PA), polycarbonate (PC), polymethyl methacrylate (PMMA) and acrylonitrile-butadiene-styrene (ABS) copolymers.

When a content of the thermoplastic elastomer is excessively low, mechanical properties or oil resistance may be deteriorated. Meanwhile, when the content of the thermoplastic elastomer is excessively high, elasticity may be deteriorated.

(2) Mixing and Heating

Next, the thermoplastic elastomer was mixed with the resin with stirring in a compounder at a rate of 40 to 100 rpm. At this time, while varying ratios of the thermoplastic elastomer to resin, the mixture was heated to about 200 to 250° C. in a compounder and was then cooled to about 50 to 110° C. in a cooling bath.

The compounder may be a melt kneader conventionally used for preparing or processing resins or thermoplastic elastomers. Here, any compounder may be used without particular limitation so long as it can simultaneously apply heat and shearing force. Specific examples of compounders include open-type mixing rolls, pressure kneaders, continuous co-rotating twin-screw extruders, continuous counter-rotating twin-screw extruders and twin-screw kneaders.

The heating conditions may be varied depending on the type of resin and thermoplastic elastomer used, the ratio therebetween and the type of melt kneader used. The heating temperature is preferably in the range of 200 to 250° C.

(3) Molding

The cooled thermoplastic elastomer-resin mixture was molded into a pellet using a pelletizer.

Accordingly, the thermoplastic elastomer-resin alloy composition of the present invention exhibits superior elasticity, soft texture, heat resistance, mechanical strength, rigidity and impact resistance, thus being useful for applications including an exterior/interior material of various products, sporting goods, protective films for semiconductors and flat panel displays, e.g., liquid crystal displays, sealers for electric parts such as hard disk gaskets, medical equipment parts, various hose tubes, sheet cushions for automobiles and motorcycles, leather sheets requiring scratch resistance and general processing products such as gaskets.

The thermoplastic elastomer-resin alloy composition of the present invention will now be described in further detail with reference to the following examples. These examples are for illustrative purposes only and are not intended to limit the scope of the present invention.

### COMPARATIVE EXAMPLE 1

10 Kg of PC was dried in a dehumidifying dryer and was injected into a feeder hopper. After the resulting PC was fed into a compounder, the compounder was heated to 260° C., while stirring at 40 to 100 rpm. The heated PC was cooled to 55° C., was pelletized and was molded into a specimen (width: 1.27 cm, length: 6 cm, thickness: 1.8 mm) using an injection molding machine.

### EXAMPLE 1

9.9 Kg of PC and 0.1 Kg of TPU were dried in a dehumidifying dryer and were then injected into respective feeder hoppers. The resulting PC and TPU were fed into a compounder, and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 2

9 Kg of PC and 1 Kg of TPU were dried in a dehumidifying dryer and were then injected into respective feeder hoppers. The resulting PC and TPU were fed into a compounder, and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 3

7 Kg of PC and 3 Kg of TPU were dried in a dehumidifying dryer and were then injected into respective feeder hoppers. The resulting PC and TPU were fed into a compounder, and were then heated to 240° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 4

5 Kg of PC and 5 Kg of TPU were dried in a dehumidifying dryer and were then injected into respective feeder hoppers. The resulting PC and TPU were fed into a compounder, and were then heated to 230° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 5

3 Kg of PC and 7 Kg of TPU were dried in a dehumidifying dryer and were then injected into respective feeder hoppers. The resulting PC and TPU were fed into a compounder, and were then heated to 220° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 6

1 Kg of PC and 9 Kg of TPU were dried in a dehumidifying dryer and were then injected into respective feeder hoppers. The resulting PC and TPU were fed into a compounder and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 7

0.1 Kg of PC and 9.9 Kg of TPU were dried in a dehumidifying dryer and were then injected into respective feeder hoppers. The resulting PC and TPU were fed into a compounder and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### COMPARATIVE EXAMPLE 2

10 Kg of TPU was dried in a dehumidifying dryer and was injected into a feeder hopper. The resulting TPU was fed into a compounder and was then heated to 170° C., while stirring at 40 to 100 rpm. The heated TPU was cooled to 55° C., was pelletized and was molded into a specimen (width: 1.27 cm, length: 6 cm, thickness: 1.8 mm) using an injection molding machine.

### EXPERIMENTAL EXAMPLE

The physical properties of the thermoplastic elastomer-resin alloy composition according to the present invention are shown in Table 1 below.

TABLE 1

| | | | Specific | | Strain | Tensile | | Tear |
|---|---|---|---|---|---|---|---|---|
| | | Hardness | gravity | Modulus | modulus | strength | Elongation | strength |
| Types | Appearance | (shore D) | (g/cm³) | (Kgf/cm²) | (%) | (Kgf/cm²) | (%) | (kgf/cm) |
| Comp. | — | 80 | 1.18 | 16,500 | 6.3 | 560 | 80 | 270 |
| Ex. 1 | | | | | | | | |
| Ex. 1 | gel | 80 | 1.18 | 16,400 | 6.3 | 560 | 80 | 268 |
| Ex. 2 | gel | 79 | 1.18 | 18,700 | 6 | 580 | 8 | 190 |
| Ex. 3 | good | 70 | 1.19 | 10,000 | 9 | 400 | 100 | 190 |
| Ex. 4 | good | 65 | 1.19 | 2,840 | x | 270 | 140 | 110 |
| Ex. 5 | | 50 | 1.19 | 610 | x | 210 | 350 | 95 |
| Ex. 6 | | 42 | 1.19 | 85 | x | 400 | 620 | 120 |
| Ex. 7 | | 40 | 1.19 | 143 | x | 570 | 708 | 111 |
| Comp. | | 40 | 1.19 | 145 | x | 575 | 710 | 110 |
| Ex. 2 | | | | | | | | |

As can be seen from Table 1 above, as the content of the resin increases, the hardness, tensile strength and tear strength increase, thus causing improvement in rigidity and abrasion resistance, and as the content of the thermoplastic elastomer increases, the elongation increases, thus causing improvement in elasticity.

Accordingly, the thermoplastic elastomer-resin alloy composition of the present invention is suitably applicable to products for interior/exterior material applications according to the characteristics of the products. In the case in which elasticity and softness are further required, the thermoplastic elastomer-resin alloy compositions of Examples 4 to 6 may be used, and in the case in which rigidity and abrasion resistance are further required, thermoplastic elastomer-resin alloy compositions of Examples 2 to 4 may be used.

Furthermore, physical and thermal properties of the thermoplastic elastomer-resin alloy composition of the present invention will be illustrated in more detail.

PC as a resin and TPU as a thermoplastic elastomer were mixed in various ratios to prepare thermoplastic elastomer-resin alloys, as set forth in Table 2 below. The physical and thermal properties of the thermoplastic elastomer-resin alloys were evaluated.

TABLE 2

| Properties | PC:TPU = 10:0 | PC:TPU = 9:1 | PC:TPU = 8:2 | PC:TPU = 7:3 | PC:TPU = 6:4 | PC:TPU = 5:5 | PC:TPU = 0:10 |
|---|---|---|---|---|---|---|---|
| Rockwell hardness | 110 | 109 | 98 | 89 | 71 | 53 | — |
| Melt index | 20 | 48 | 97 | 190 | 215 | 230 | — |
| Young's modulus | 1,640 | 1,700 | 1,400 | 1,050 | 620 | 300 | 150 |
| Tensile strength at | 59 | 55 | 44 | 35 | — | — | — |
| yield point | | | | | | | |
| Tensile strength at | 57 | 58 | 61 | 41 | 35 | 30 | 31 |
| break point | | | | | | | |
| Elongation at yield | 6.4 | 5.7 | 6.1 | 8.2 | — | — | — |
| point | | | | | | | |
| Elongation at break | 83 | 100 | 100 | 90 | 108 | 115 | 450 |
| point | | | | | | | |
| Flexural strength | 88 | 84 | 67 | 50 | 33 | 17 | 3 |
| Flexural modulus | 1,920 | 1,900 | 1,460 | 1,050 | 640 | 280 | 41 |
| Impact strength | 660 | 580 | 560 | 450 | 410 | 380 | NB |
| at 23° C. | | | | | | | |
| Thermal deflection | 117 | 103 | 98 | 88 | 73 | 50 | — |
| temperature | | | | | | | |

Rockwell hardness: ASTM D785 (unit: g/cm³)
Melt index: ASTM D1238 (unit: g/10 min)
Tensile strength and elongation: ASTM D638 (tensile strength unit: MPa, elongation unit; %)
Flexural strength and Flexural modulus: ASTM D790 (unit: MPa)
Impact strength: ASTM D256 (unit: J/m)
Thermal deflection temperature: ASTM D648 (unit: ° C.)

As can be seen from Table 2 above, as the content of PC increases, Rockwell hardness, tensile strength, flexural strength, flexural modulus, impact strength, and heat deflection temperature increase. Accordingly, rigidity, abrasion resistance and impact resistance, the requirements of interior/exterior materials, are improved, and as the content of TPU increases, the melt index increases. Accordingly, as the content of TPU increases, processability is increased. Consequently, the thermoplastic elastomer-resin alloy of the present invention exhibits the rigidity and abrasion resistance required for an interior/exterior material, and secures a high processability and softness.

In other words, as can be seen from Table 2, the thermoplastic elastomer-resin alloy composition of the present invention exhibits superior mechanical properties, heat resistance and processability.

### EXPERIMENTAL EXAMPLE 2

The thermoplastic elastomer-resin alloy composition was compared with the prior art (Korean Patent Laid-open No. 1999-021569). The comparison results in the impact strength and heat deflection temperature of various physical properties are shown in Table 3.

TABLE 3

| Properties | The present invention | Prior art |
|---|---|---|
| Impact strength | 380~580 | 12~18 |
| (Kgf/cm²) | | |
| Thermal deflection temperature | 50~105 | About 80° C. |
| (° C.) | | |

As can be seen from Table 3 above, the present invention provides about a 20-fold increase in impact strength, as compared to the prior art and can control heat deflection temperature according to modification in ratios of PC and TPU.

That is, in comparison with the prior art, the present invention enables preparation of a thermoplastic elastomer-resin alloy composition that exhibits superior physical properties in a relatively simple manner without adding any other compounds such as mixing agents, fillers, initiating agents and crosslinking agents.

According to the present invention, a novel thermoplastic elastomer-resin alloy composition is obtained that has both the characteristics of thermoplastic elastomers (e.g., elasticity, soft texture, impact absorption, color variety and waterproofing) and the characteristics of resins (e.g., mechanical strength and rigidity). Furthermore, the novel thermoplastic elastomer-resin alloy of the present invention may be commercialized into products by general injection molding, thus reducing processing costs and time, while realizing slim and lightweight products.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A thermoplastic elastomer-resin alloy composition comprising:
1 to 99% by weight of a thermoplastic elastomer; and
1 to 99% by weight of a resin.

2. The composition according to claim 1, wherein the thermoplastic elastomer is at least one selected from the group consisting of thermoplastic urethane elastomers, thermoplastic ester elastomers, thermoplastic styrene elastomers, thermoplastic olefin elastomers, thermoplastic polyvinyl chloride elastomers and thermoplastic amide elastomers.

3. The composition according to claim 1, wherein the resin is a thermoplastic plastic.

4. The composition according to claim 3, wherein the thermoplastic plastic is at least one selected from the group consisting of polyvinyl chloride (PVC), polystyrene (PS), polyethylene (PE), polypropylene (PP), acryl, nylon (PA), polycarbonate (PC), polymethyl methacrylate (PMMA) and acrylonitrile butadiene styrene (ABS) copolymers.

5. A method to prepare a thermoplastic elastomer-resin alloy composition comprising:
heating 1 to 99% by weight of a dried thermoplastic elastomer and 1 to 99% by weight of a dried resin with stirring;
cooling the resulting mixture; and
pelletizing the mixture, followed by drying.

6. The method according to claim 5, wherein the thermoplastic elastomer is at least one selected from the group consisting of thermoplastic urethane elastomers, thermoplastic ester elastomers, thermoplastic styrene elastomers, thermoplastic olefin elastomers, thermoplastic polyvinyl chloride elastomers and thermoplastic amide elastomers.

7. The method according to claim 5, wherein the resin is a thermoplastic plastic.

8. The method according to claim 7, wherein the thermoplastic plastic is at least one selected from the group consisting of polyvinyl chloride (PVC), polystyrene (PS), polyethylene (PE), polypropylene (PP), acryl, nylon (PA), polycarbonate (PC), polymethyl methacrylate (PMMA) and acrylonitrile butadiene styrene (ABS) copolymers.

9. The method according to claim 5, wherein the thermoplastic elastomer and the resin are heated to 200 to 250° C.

10. The method according to claim 5, wherein the thermoplastic elastomer and the resin are stirred at a rate of 40 to 100 rpm.

11. The method according to claim 5, wherein the heated mixture is cooled to 50 to 110° C.

12. The method according to claim 6, wherein the thermoplastic elastomer and the resin are heated to 200 to 250° C.

13. The method according to claim 7, wherein the thermoplastic elastomer and the resin are heated in a range of 200 to 250° C.

14. The method according to claim 8, wherein the thermoplastic elastomer and the resin are heated to 200 to 250° C.

15. The method according to claim 6, wherein the thermoplastic elastomer and the resin are stirred at a rate of 40 to 100 rpm.

16. The method according to claim 7, wherein the thermoplastic elastomer and the resin are stirred at a rate of 40 to 100 rpm.

17. The method according to claim 8, wherein the thermoplastic elastomer and the resin are stirred at a rate of 40 to 100 rpm.

18. The method according to claim 6, wherein the heated mixture is cooled to 50 to 110° C.

19. The method according to claim 7, wherein the heated mixture is cooled to 50 to 110° C.

20. The method according to claim 8, wherein the heated mixture is cooled to 50 to 110° C.

21. A thermoplastic elastomer-resin alloy composition comprising: 1 to 99% by weight of a thermoplastic elastomer thermally alloyed with 1 to 99% by weight of a resin.
